(19) United States
(12) Patent Application Publication
(10) Pub. No.: US 2024/0306692 A1
(43) Pub. Date: Sep. 19, 2024

(54) Fluid-less powdered edible energy composition and method of use thereof

(71) Applicant: David Ross Kniffen, Troy, MI (US)

(72) Inventor: David Ross Kniffen, Troy, MI (US)

(21) Appl. No.: 18/123,056

(22) Filed: Mar. 17, 2023

(51) Int. Cl. A23L 33/175; A23L 33/125; A23L 33/15

(52) U.S. Cl. CPC A23L 33/175; A23L 33/125; A23L 33/15

(57) ABSTRACT

A fluid-less powdered edible energy composition comprising caffeine and real cane sugar in an amount sufficient to render the energy composition palatable. The fluid-less powdered energy composition may also comprise amino acids, vitamins and the like. The fluid-less powdered edible energy supplement, by design, is to be consumed by a non-obvious and unique method of oral intake in its pre packaged dry form, without mixing with any liquid; eaten as powder.

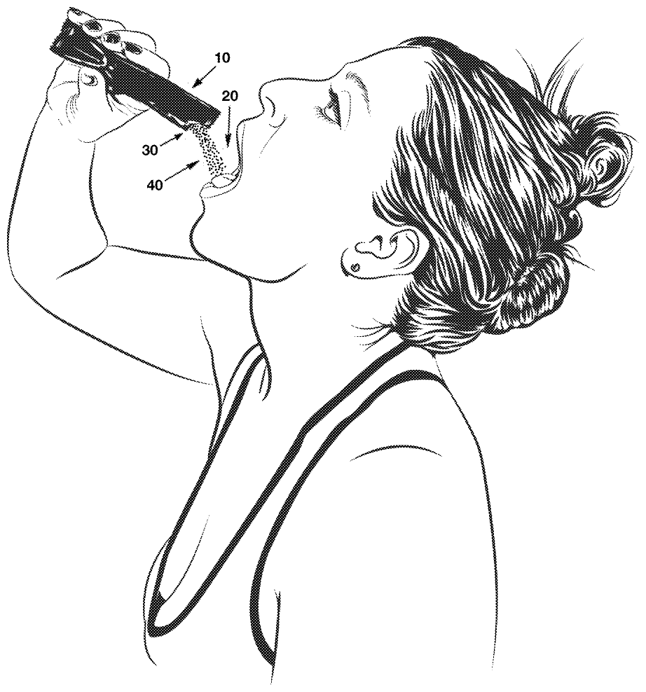

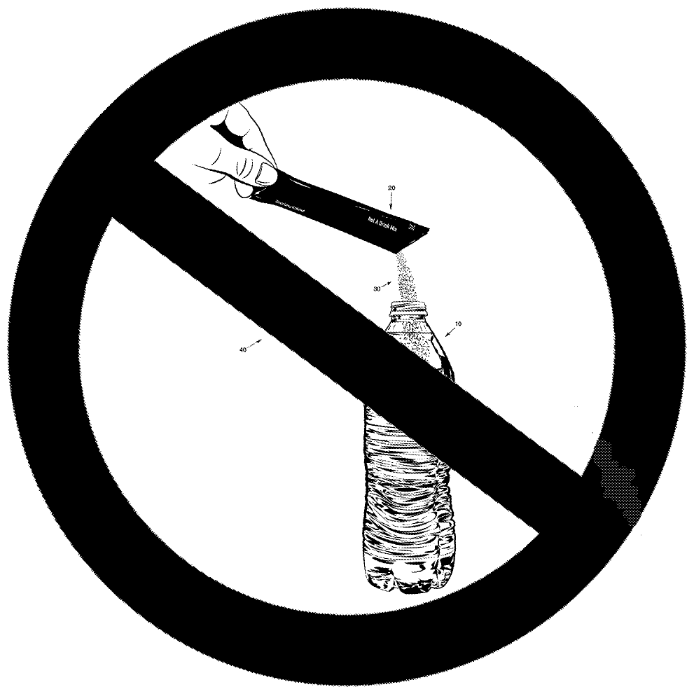

### FIELD OF THE INVENTION

The present invention relates to a fluid-less powdered edible energy composition that provides the individual user with an immediate energy burst, with continued endurance sensation when consumed directly orally in powdered form and method of consuming such composition.

### BACKGROUND ART

Energy drinks, shots, and drink mixes are supplements that provide the individual users with an energy boost upon ingestion. This uptick in energy comes from the intake of caffeine into the human body. This is a chemical that is added to soft drinks as well as found in coffee, all of which often consumed for the same reason. Caffeine itself is of a bitter taste to humans and its extract by itself is unpleasant to ingest without being added to an enjoyable masking carrier.

Almost universally , when offered as a product to enjoy when consumed, the carrier of the caffeine consumable is a liquid. This typically comes in the form of a beverage, drink, shot; or a powder mix which must first be combined with a fluid, (typically water) to consume. Otherwise, to no mix with liquid would render such composition so repugnant and intolerable that it would sicken the user. No other prior art even suggests, hints or at their users ability to ingest an energy composition without a liquid carrier, whether it comes made up as a beverage or shot, of if the user is supposed to mix the composition themselves in a liquid. However, consuming a caffeinated beverage is not always an optimal solution to the user. Caffeine is a diuretic, which combined with the drinking a large amount of fluid, can cause the user to urinate frequently. This can be counter productive to the purpose of the caffeine intake to begin with, which is often used to stay awake for driving, work, or other useful productivity. Such productivity would be hindered with frequent use of the bathroom.

While the market offers several products in each of the noted energy supplement categories, including the powdered mix energy supplements. None of the powdered energy supplements can be ingested directly in powdered form without mixing with a generous amount of liquid, as the taste and consistency would shock and sicken the user. Consumers demand unique options and formulations in which they are able to achieve perceived energy bursts through enjoyable caffeine consumption. They seek good tasting products which also offer additional health benefits, with as little as possible downsides. Therefore, such a need exists to meet this demand of a consumable energy composition that provides for an enjoyable caffeine intake; as well as nutritional vitamins, that can be ingested without any liquid intake, and yet offers a palatable taste and consistency for enjoyment.

### SUMMARY OF THE INVENTION

The present invention solves one or more of the issues noted in the prior art by design and invention of a fluid-less powdered edible energy composition and method of use thereof. The fluid-less powdered edible energy composition of this embodiment includes caffeine, and sugar in an amount sufficient to render the composition palatable and may also comprise amino acids, and vitamins, preservatives and the like, in powdered form. The method of consuming the energy composition is for the user to ingest the powdered energy composition, directly, in its powdered form, without mixing, preparing, or diluting in any way. Such method of oral ingestion comprises opening a pre-portioned package or container, and pouring the powdered energy composition directly into the mouth of the user. Advantageously, the effects of this present invention, a powdered energy composition, are expedited, both in the users ability to consume and in the body's ability to absorb. Further, this method of consumption allows the user to forego any and all dis-advantages associated with liquid consumption of fluid based energy compositions, or compositions that require mixing with a fluid based carrier, or any other liquid of the like. This may include consuming unpalatable energy beverages; storing and transporting liquid energy beverages when space is of concern; temperature effects on liquid energy based compositions; spillage of liquid based energy compositions, both during consumption and or mixing of energy based compositions with liquids; staining of the teeth associated with certain energy beverages; calorie intake of certain liquid based energy compositions; and frequented or irregular bathroom usage resulting from consumption of certain liquid based energy compositions.

In another representation or embodiment, a fluid-less powdered edible energy composition comprises caffeine in an amount of 1% wt to about 1.5% wt, vitamins and minerals in an amount from 6% wt to about 9.2% wt, amino acids or subsidiary product thereof in an amount from 12% wt to about 24% wt, and sugar in an amount no less than 50% in so much sufficient to cause or allow the composition to be palatable.

Additionally, another representation or embodiment, the fluid-less powdered edible energy composition comprises caffeine in an amount of 3% wt to about 6% wt, vitamins and minerals in an amount from 2.2% wt to about 4.9% wt, amino acids or subsidiary product thereof in an amount from 5% wt to about 20% wt, and sugar in an amount no less than 60% in so much sufficient to cause or allow the composition to be palatable.

### BRIEF DESCRIPTION OF THE DRAWINGS

The present invention, in its various embodiments and method of use thereof solves the problems discussed herein and remarkably advances the technology of energy consumables and administration thereof. This invention can become more fully understood from the accompanied drawings wherein:

Drawing 1/2 is a three (3) dimensional action drawing of a person consuming the present invention, a fluid-less powdered edible energy composition from its pre-packaged packet, displaying the claimed method of consumption: Wherein;

Item 10, is the pre-packaged packet containing the present invention of the fluid-less powdered edible energy composition;

Item 20, is the person's open mouth to consume the powdered energy composition orally, directly from the package;

Item 30, is a tear in the packet which contains the fluid less powdered edible energy composition, allowing the powder to flow out of the package when tilted in such a manner;

Item 40, is the powdered edible energy composition, flowing out of the packet directly into the mouth of the user in the preferred and claimed method of use thereof.

Drawing 2/2 is a three (3) dimensional action drawing of a hand pouring the present invention, a fluid-less powdered edible energy composition from its pre-packaged packet into a bottle of water, with a large black cross out mark which is generally understood as the prohibition symbol over the top of the action illustration, denoting to do not do said action as shown. Thus, figure B serves as a representation of what the the present invention is not, and what the method of of consumption is not to be. This is shown as a contrast illustration to how prior art is used and perceived;

Wherein;

Item 10, is a standard generic bottle of commercially available spring water;

Item 20, is the pre-packaged packet containing the present invention of the fluid-less powdered edible energy composition, with an advisory message printed on the package stating, “Not A Drink Mix”;

Item 30, is the powdered edible energy composition, flowing out of the packet directly into the mouth of the user in the preferred and claimed method of use thereof.

Item 40, is a large black cross out mark, generally understood as the prohibition symbol over the top of the action illustration, denoting to do not do said action.

### DETAILED DESCRIPTION OF THE INVENTION

The formulation described herein comprising a fluid-less powdered edible energy composition can be enjoyed for taste, health benefits and a temporary boost of energy in the human body. The method for which the user consumes or otherwise ingests the invention, is in its created form, as a powder based composition, absent of any liquid, or fluid. The composition is packaged in ready to eat form, and when package is opened the powdered contents are poured directly into the mouth in its powdered form, and then eaten like a food would be, once it has entered the mouth. This method is both non-obvious and unique and as such the concept is reiterated to the fact the dry powder form is in its edible state and consumed as such powder, as that is not the case with any background art. Any redundancy in terms like powder, fluid-less, dry and non liquid is merely to reinforce the understanding of the method of consumption.

The formulations disclosed herein can vary in representations, and embodiments, the following will represent the fluid-less powdered edible energy composition presently preferred as the leading manner of practicing the invention as known to the inventor. Nevertheless, be it acknowledged that such divulged embodiments are simply ideal forms of the invention that may be embodied in different forms. Details given herein are not designed to limit the invention, but provide an embodiment basis for explaining any aspect of it and to teach how to implement the invention itself.

The subsequent details the embodiment is simply a specimen and is in no way intended to restrict the invention, utilization, or application. In an embodiment of the present invention, a fluid-less powdered edible energy composition is prepared. This energy composition includes sugar, a stimulant, vitamins and amino acids.

Variations of the present invention also include caffeine. In a refinement, the caffeine is present in an amount from about 1.8% wt to about 3.2% wt. In another refinement, the caffeine is present in an amount from about 1% wt to about 1.5% wt. In still another refinement, the caffeine is present in an amount from about 3% wt to about 6% wt.

Variations of the present invention also include a sweetener. The specific amounts, ratios and proportions of sweeteners are crucial so as to reach a defined perfected palatability of not too sweet and overbearing but masking of the various energy and vitamin components. In a refinement, the preferred sweetener used is granulated cane sugar, present in an amount from about 67.9% wt to about 75.2% wt. In another refinement, the sugar is present in an amount from about 61% wt to about 65% wt. In still another refinement, the sugar is present in an amount from about 53% wt to about 59% wt.

In a variation of the present embodiment, the energy composition further comprises one or more vitamins. Examples of such vitamins include, but are not limited to B6, zinc (L-Asparate), niacin, ascorbic acid (vitamin C), and the like. In a refinement, vitamins are present in an amount from about 4.1% wt to about 5.7 wt. In another refinement, vitamins are present in an amount from about 6% wt to about 9.2% wt. In still another refinement, vitamins are present in an amount from about 2.2% wt to about 4.9%. As set forth above, the energy composition may include vitamin B6. In a refinement, the B6 is present in an amount from about 0.7% wt to about 1.1% wt. In another refinement, the B6 is present in an amount from about 1.2% wt to about 1.9% wt. In still another refinement, the B6 is present in an amount from about 0.2% wt to about 0.8% wt. As set forth above, the energy composition may include zinc as L-asparate. In a refinement, the zinc is present in an amount from about 1.1% wt to about 1.4% wt. In another refinement, the zinc is present in an amount from about 1.3% wt to about 2.3% wt. In still another refinement, the zinc is present in an amount from about 0.5% wt to about 1.3% wt. As set forth above, the energy composition may include niacin. In a refinement, the niacin is present in an amount from about 0.6% wt to about 0.8% wt. In a refinement, the niacin is present in an amount from about 0.9% wt to about 1.7% wt. In another refinement, the niacin is present in an amount from about 0.1% wt to about 0.7% wt. As set forth above, the energy composition may include ascorbic acid (vitamin C). In a refinement, the ascorbic acid is present in an amount from about 1.9% wt to about 2.3% wt. In a refinement, the ascorbic acid is present in an amount from about 2.4% wt to about 3.7% wt. In another refinement, the ascorbic acid is present in an amount from about 0.9% wt to about 2.0% wt.

In another variation of the present embodiment, the energy composition further comprises one or more amino acids or amino acid derivatives. Examples of amino acids or derivatives thereof, include, but are not limited to, taurine, L-tyrosine, L-glutamine, malic acid and combinations thereof. In a refinement, amino acids or derivatives thereof are present in an amount from about 8.7% wt to about 12.5% wt. In a refinement, amino acids or derivatives thereof are present in an amount from about 11.9% wt to about 19.1% wt. In still another refinement, amino acids or derivatives thereof are present in an amount from about 4.4% to about 8.8%. As set forth above, the energy composition may include L-tyrosine. In a refinement, L-tyrosine is present in an amount from about 1.7% wt to about 2.3% wt. In a refinement, L-tyrosine is present in an amount from about 2.3% wt to about 3.9% wt. In still another refinement, L-tyrosine is present in an amount from about 0.8% wt to about 1.7% wt. As set forth above, the energy composition may include L-glutamine. In a refinement, L-glutamine is present in an amount from about 1,7% wt to about 2.4% wt. In a refinement, L-glutamine is present in an amount from about 2.3% wt to about 3.8% wt. In still another refinement, L-glutamine is present in an amount from about 0.9% wt to about 1.7% wt. As set forth above, the energy composition may include taurine. In a refinement, taurine is present in an amount from about 3.1% wt to about 4.9% wt. In a refinement, taurine is present in an amount from about 4.6% wt to about 6.7% wt. In still another refinement, taurine is present in an amount from about 1.8% wt to about 3.8% wt. As set forth above, the energy composition may include magic acid. In a refinement, malic acid is present in an amount from about 1.6% wt to about 2.2% wt. In a refinement, malic acid is present in an amount from about 2.1% wt to about 3.6% wt. In still another refinement, malic acid is present in an amount from about 0.8% wt to about 1.4% wt.

In still another variation of the present embodiment, the energy composition of the present invention further includes additional components that promote energy production. Such additional components include, for example riboflavin. In a refinement, riboflavin is present in an amount from about 0.0001% wt to about 0.012% wt. In a refinement, riboflavin is present in an amount from about 0.0003% wt to about 0.0009% wt. In still another refinement, riboflavin is present in an amount from about 0.0009% wt to about 0.002% wt.

In yet another variation of the present invention, the energy composition further comprises a preservative. In a refinement, the preservative is a natural preservative. Examples of useful preservatives include, but are not limited to, tartaric acid, tri-calcium phosphate and derivatives, and/or combinations thereof; In a refinement, the preservative is present in an amount from about 4% wt to about 8% wt. In a refinement, the preservative is present in an amount from about 7.2% wt to about 10.7% wt. In still another refinement, the preservative is present in an amount from about 0 to about 5.5% wt. As set forth above, the energy composition may include tartaric acid. In a refinement, tartaric acid is present in an amount from about 1.1% wt to about 2.3% wt. In a refinement, tartaric acid is present in an amount from about 2.6% wt to about 3.9% wt. In still another refinement, tartaric acid is present in an amount from about 0.0% wt to about 1.8% wt. As set forth above, the energy composition may include tri-calcium phosphate. In a refinement, tri-calcium phosphate is present in an amount from about 1.5% wt to about 2.9% wt. In a refinement, tri-calcium phosphate. is present in an amount from about 1.8% wt to about 3.3% wt. In still another refinement, tri-calcium phosphate. is present in an amount from about 0.0% wt to about 1.3% wt. As set forth above, the energy composition may include sodium citrate. In a refinement, sodium citrate. is present in an amount from about 1.4% wt to about 2.8% wt. In a refinement, sodium citrate. is present in an amount from about 2.8% wt to about 3.5% wt. In still another refinement, sodium citrate is present in an amount from about 0.0% wt to about 2.6% wt.

The compositions of the present invention are made by introducing certain amounts of ingredients as noted or set forth above together to create the composition. A set of tables 1 through 3, outlines the components that may comprise the possible and suitable embodiments of the invention. The tables 1 through 3, provide the percentage amounts of the ingredients in which are specifically useful to form the composition of the invention, with such composition having a total final weight of 4 grams.

TABLE 1
Fluid-less powdered edible energy composition

| Component | Amount % by weight |
|---|---|
| Caffeine | 1.8% to 3.2% |
| Sweetener | |
| Sugar | 67.9% to 75.2% |
| Vitamins | |
| B6 | 0.7% to 1.1% |
| Zinc | 1.1% to 1.4% |
| Niacin | 0.6% to 0.8% |
| C | 1.9% to 2.3% |
| Amino Acids | |
| Taurine | 3.1% to 4.9% |
| L-Tyrosine | 1.7% to 2.3% |
| L-Glutamine | 1.7% to 2.4% |
| Malic Acid | 1.6% to 2.2% |
| Other | |
| Riboflavin | 0.0001% to 0.012% |
| Preservatives/Misc | |
| Tartaric Acid | 1.1% to 2.3% |
| Tri Calcium Phospate | 1.5% to 2.9% |
| Sodium Citrate | 1.4% to 2.8% |

TABLE 2
Fluid-less powdered edible energy composition

| Component | Amount % by weight |
|---|---|
| Caffeine | 1.0% to 1.5% |
| Sweetener | |
| Sugar | 61.0% to 65.0% |
| Vitamins | |
| B6 | 1.2% to 1.9% |
| Zinc | 1.3% to 2.3% |
| Niacin | 0.9% to 1.7% |
| C | 2.4% to 3.7% |
| Amino Acids | |
| Taurine | 4.6% to 6.7% |
| L-Tyrosine | 2.3% to 3.9% |
| L-Glutamine | 2.3% to 3.8% |
| Malic Acid | 2.1% to 3.6% |
| Other | |
| Riboflavin | 0.0003% to 0.0009% |
| Preservatives/Misc | |
| Tartaric Acid | 2.6% to 3.9% |
| Tri Calcium Phospate | 1.8% to 3.3% |
| Sodium Citrate | 2.8% to 3.5% |

TABLE 3
Fluid-less powdered edible energy composition

| Component | Amount % by weight |
|---|---|
| Caffeine | 3.0% to 6.0% |
| Sweetener | |
| Sugar | 53.0% to 59.0% |
| Vitamins | |
| B6 | 0.2% to 0.8% |
| Zinc | 0.5% to 1.3% |
| Niacin | 0.1% to 0.7% |
| C | 0.9% to 2.0% |
| Amino Acids | |
| Taurine | 1.8% to 3.8% |
| L-Tyrosine | 0.8% to 1.7% |
| L-Glutamine | 0.9% to 1.7% |
| Malic Acid | 0.8% to 1.4% |
| Other | |
| Riboflavin | 0.0009% to 0.002% |
| Preservatives/Misc | |
| Tartaric Acid | 0.0% to 1.8% |
| Tri Calcium Phospate | 0.0% to 1.3% |
| Sodium Citrate | 0.0% to 2.6% |

Drawing 1/2 depicts the exemplary method for which the fluid-less edible powdered energy composition is to be consumed in accordance with the principles of the present invention. Wherein the human user, opens the energy composition from its pre-measured and pre-packaged unit, and will then pour the dry powdered composition directly in the mouth for consumption. The composition contains no liquid, and it not mixed with any fluid or liquid to be consumed. The method coincides with and is inseparable from the present composition invention which is unique to its design itself, non-obvious and unlike any prior art. The method of consumption stands in contrast to all prior art which is aqueous in its consumable form. Attempting to consume any prior art in this method would be repugnant to the user, and as such not the likely or plain conclusion for consumption of any powdered energy composition. Thus, as show in Drawing 2/2, item 10, the present invention and method of consumption contained herein must be explicitly marked and designated that composition is in fact not a drink mix and is to be eaten in dry powdered form to avoid confusion and misuse.

While representations and embodiments of the invention are illustrated, noted and described, it is not intended that such representations are all inclusive of all the forms of the invention. It is understood that many changes may be made without straying from the spirit and breadth of the invention because the language used in the specification are ones of description rather than limitation.

It is understood that various changes can be made without deviating from the spirit and scope of the invention because the words used in the specification are words of description rather than limitation.

What is hereby claimed is:

1. A fluid-less edible powdered energy composition comprising of: caffeine, sugar, amino acids, and vitamins,

2. The energy composition of claim 1 wherein the caffeine is present in an amount from about 0.1% wt. to about 10.0% wt.

3. The energy composition of claim 1, wherein the composition is not intended to be combined, diluted or mixed with anything before orally ingested, including liquid of any kind.

4. A method of consuming an energy composition dry, by eating or otherwise ingesting orally in a powdered form; fluid-less and not requiring preparation, mixing or dilution in liquid to consume.

5. The method of claim 4, further comprising; ingestion of the fluid-less edible powdered energy composition from a pre-portioned package or container, which is first opened and then poured directly into the mouth of the user, in its dry powdered state, and eaten or otherwise swallowed.

6. A fluid-less edible powdered energy composition consisting of: caffeine in an amount from about 0.1% wt. to about 10.0% wt.; L-tyrosine, L-Glutamine, and Taurine each in an amount from about 0.5% wt. to about 8.0% wt.; vitamin B6, vitamin C, and Zinc each in an amount from about 0.1% wt. to about 5.0% wt.
